(19) United States
(12) Patent Application Publication
(10) Pub. No.: US 2015/0003317 A1
(43) Pub. Date: Jan. 1, 2015

(54) RELAY DEVICE, NETWORK COMMUNICATION SYSTEM, METHOD AND NON-TRANSITORY COMPUTER READABLE MEDIUM

(71) Applicant: KABUSHIKI KAISHA TOSHIBA, Tokyo (JP)

(72) Inventors: Yoshihiro OBA, Kawasaki-Shi (JP); Mitsuru Kanda, Tokyo (JP); Yasuyuki Tanaka, Tokyo (JP)

(21) Appl. No.: 14/313,399

(22) Filed: Jun. 24, 2014

(30) Foreign Application Priority Data
Jun. 28, 2013 (JP) 2013-137203

(51) Int. Cl. H04B 7/155; H04L 12/715

(52) U.S. Cl. CPC H04B 7/15507; H04L 45/04
USPC 370/315

(57) ABSTRACT

According to one embodiment, there is provided a relay device including: a first connection unit to connect to a first network; a second connection unit to connect to a second network; a virtual link management unit to control setting and releasing of a virtual link to logically connect a gateway existing in the second network to the first network, according to a predetermined condition; a relay processing unit to determine a relay destination of a packet received from the first network; and a virtual link transmission/reception unit to transmit the packet to the gateway in association with the virtual link, when the relay destination of the packet is determined to be the gateway and the virtual link is set to the gateway.

### CROSS-REFERENCE TO RELATED APPLICATIONS

This application is based upon and claims the benefit of priority from Japanese Patent Application No. 2013-137203, filed on Jun. 28, 2013; the entire contents of which are incorporated herein by reference.

### FIELD

Embodiments described herein relate to a relay device, a network communication system, a method and a non-transitory computer readable medium.

### BACKGROUND

A method of dividing an access point function into a WTP (Wireless Termination Point) having a PHY function and an AC (Access Controller) not having the PHY function and constructing a wireless LAN system in which one AC controls a plurality of WTPs is conventionally proposed. By this method, a large-scale wireless LAN system can be realized at a lower cost compared to the case of construction using a plurality of access points.

In this method, it is assumed that a terminal and the WTP are connected by one hop, and application to multihop wireless of IEEE 802.15.4 or the like is difficult. Also, when an AC fails, individual WTPs which are control objects of the AC and terminals connected to the individual WTPs all become incommunicable. When an AC is made redundant, the cost of the wireless LAN system increases.

### BRIEF DESCRIPTION OF THE DRAWINGS

FIG. 1 illustrates a communication system according to a first embodiment;

FIG. 2 illustrates one configuration of an interworking relay related to the first embodiment;

FIG. 3 illustrates one configuration of an interworking gateway related to the first embodiment;

FIG. 4 illustrates a flowchart of operations during MAC frame transmission and reception of the interworking relay according to the first embodiment;

FIG. 5 illustrates a flowchart of operations during MAC frame transmission and reception of the interworking gateway according to the first embodiment;

FIG. 6 illustrates examples of device descriptors;

FIG. 7 illustrates examples of virtual link management information;

FIG. 8 illustrates a protocol stack according to the first embodiment;

FIG. 9 illustrates a virtual link setting sequence initiated by the interworking relay;

FIG. 10 illustrates a virtual link setting sequence initiated by the interworking gateway;

FIG. 11 illustrates a virtual link release sequence initiated by the interworking relay;

FIG. 12 illustrates a virtual link release sequence initiated by the interworking gateway;

FIG. 13 illustrates one example of an interworking protocol message format;

FIG. 14 illustrates a correspondence table of option attributes of an interworking protocol message;

FIG. 15 illustrates a multihop MAC frame transfer sequence on a virtual link, using an interworking protocol;

FIG. 16 illustrates an example of a packet format; and

FIG. 17 illustrates a communication system according to a second embodiment.

### DETAILED DESCRIPTION

According to one embodiment, there is provided a relay device including a first connection unit, a second connection unit, a virtual link management unit, a relay processing unit and a virtual link transmission/reception unit.

The first connection unit connects to a first network.

The second connection connects to a second network.

The virtual link management unit controls setting and releasing of a virtual link to logically connect a gateway existing in the second network to the first network, according to a predetermined condition.

The relay processing unit determines a relay destination of a packet received from the first network.

The virtual link transmission/reception unit transmits the packet to the gateway in association with the virtual link, when the relay destination of the packet is determined to be the gateway and the virtual link is set to the gateway.

Hereinafter, an embodiment of the present invention will be described.

### First Embodiment

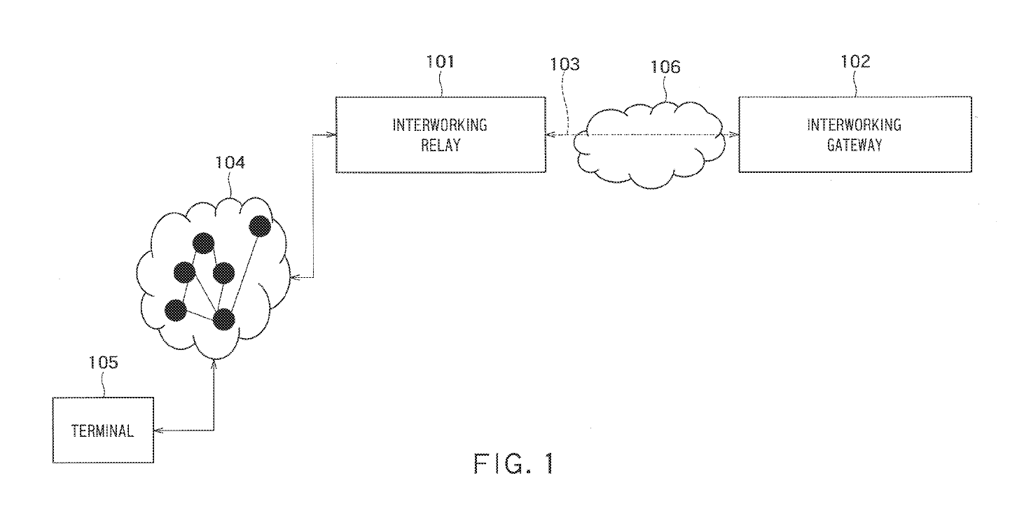

FIG. 1 illustrates a communication system according to the first embodiment.

The communication system according to the first embodiment includes an interworking relay 101, an interworking gateway 102, a multihop access network (first network) 104, a terminal 105, and an interworking network (second network) 106. In the multihop access network 104 and the interworking network 106, different kinds of MAC (Media Access Control) protocols are used respectively. The MAC protocol of the multihop access network 104 is sometimes called a multihop MAC. A virtual link 103 is formed between the interworking relay 101 and the interworking gateway 102, and logically connects the interworking gateway 102 on the interworking network 106 to the multihop access network 104. In transmission and reception through the virtual link 103, a frame of the multihop MAC is included in a frame of MAC of the interworking network 106.

The multihop access network 104 is a multihop access network in which a plurality of wireless devices (nodes) relay the frame by radio. Black circles in the figure indicate the wireless devices. Each wireless device has a function of relaying the MAC frame received from another wireless device to further another wireless device. By the relay function, the wireless devices incapable of direct communication can communicate with each other. As an example of the wireless device, a smart meter can be used.

There are cases that a gateway for connecting a core network such as the Internet is connected to the multihop access network 104 (In this case, one of the black circles in the figure may indicate the gateway). In this case, the respective wireless devices can access the core network through the gateway. The respective wireless devices are connected to the gateway directly or through relay by the other wireless devices. Hereinafter, the gateway is distinguished from the interworking gateway 102 illustrated in FIG. 1 and is called a gateway node.

The terminal 105 is an arbitrary communication terminal connected to the multihop access network 104. The terminal may be one of the wireless devices configuring the multihop access network 104 or may be a terminal (a mobile terminal or a desktop terminal or the like) that a user can operate.

As the MAC protocol of the multihop access network 104, IEEE 802.15.4 may be used. In this case, whether or not the gateway node is connected to the multihop access network 104, a PAN coordinator of IEEE 802.15.4 is connected to the multihop access network 104.

A main role of the PAN coordinator is allocation of PAN Id. When the gateway node is connected to the multihop access network 104, the gateway node may provide a function of the PAN coordinator. When the gateway node is not connected to the multihop access network 104, the interworking relay 101 or the interworking gateway 102 described later may provide the function of the PAN coordinator.

Route control inside the multihop access network 104 may be performed in an IP layer or may be performed in a layer of a lower order than the IP layer. When performing the route control in the IP layer, as a route control protocol of the IP layer, RPL stipulated by RFC6550 may be used. The layer of the lower order than the IP layer may be a MAC layer or a different layer of the higher order than the MAC layer and the lower order than the IP layer.

The interworking network 106 is an IP network of an arbitrary type, and may be a wireless network such as a mobile telephone network or a wired network.

The interworking relay 101 is connected to both of the multihop access network 104 and the interworking network 106. The interworking relay 101 may be one of the wireless devices configuring the multihop access network 104, may be a communication module loaded on the wireless device, or may be a device completely different from the wireless devices configuring the multihop access network 104. The communication module may be a device of a type that can be attached later to the wireless device or may be one of a type that is incorporated in the wireless device beforehand. Also, a function of the interworking relay 101 may be configured as a program module. In this case, by executing the program module by a computer, the function of the interworking relay 101 is realized.

The interworking gateway 102 is connected to the interworking network 106. In a typical configuration, the interworking gateway 102 is connected also to the core network not shown in the figure, such as the Internet, in addition to the interworking network 106. In order to form a virtual link, to the interworking gateway 102, a multihop MAC address is allocated in addition to a MAC address of the interworking network 106. Also, in the case of a configuration connected to the core network, a MAC address in the core network is further allocated. Also, the interworking gateway 102 may be connected to a multihop access network different from the multihop access network 104.

The interworking relay 101 has a function of controlling setting and releasing of the virtual link 103 with the interworking gateway 102 on the basis of predetermined conditions (for instance, network communication quality or an instruction request from the interworking gateway 102 or the like. Details will be described later). The interworking relay has a function of relaying a packet of the MAC frame received from the multihop access network 104 to the interworking gateway 102 using the virtual link 103. That is, the multihop MAC frame including the packet is included in the frame of the MAC of the interworking network 106 and transmission is performed. To the interworking relay 101, the multihop MAC address and the MAC address of the interworking network 106 are allocated.

When the core network cannot be accessed due to a fault of the gateway node inside the multihop access network 104, for instance, by sending the multihop MAC frame to the interworking gateway 102 through the virtual link 103, the core network can be accessed through the interworking gateway 102.

In a configuration illustrated in FIG. 1, one interworking relay 101 is connected to one multihop access network 104, however, a plurality of interworking relays can be connected to one multihop access network 104.

Also, in the configuration illustrated in FIG. 1, the interworking gateway with which one interworking relay 101 communicates is one of the interworking gateways 102, however, a plurality of interworking gateways may be disposed to be able to communicate with the respective interworking gateways (including communication by the virtual link). Also, a plurality of interworking relays may be disposed to have one interworking gateway communicate with the respective interworking relays.

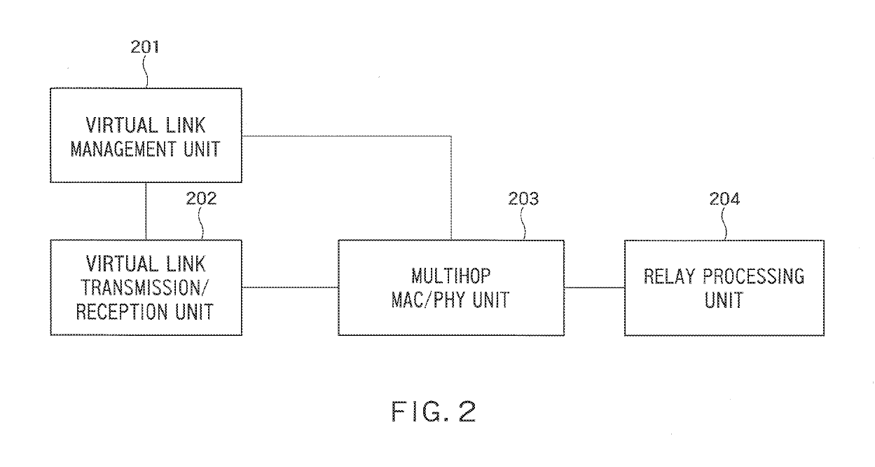

Next, one configuration of the interworking relay related to the first embodiment is illustrated in FIG. 2.

In FIG. 2, the interworking relay includes a virtual link management unit 201, a virtual link transmission/reception unit 202, a multihop MAC/PHY unit 203, and a relay processing unit 204. The multihop MAC/PHY unit 203 includes a first connection unit connected to the multihop access network 104, and the virtual link transmission/reception unit 202 includes a second connection unit connected to the interworking network 106.

The virtual link management unit 201 executes control (validation and invalidation of the virtual link) related to the setting of the virtual link. The virtual link management unit may control the validation and invalidation corresponding to the number of connectable multihop access networks. As a concrete example, when the interworking relay which is a present node is connectable to the plurality of multihop access networks, the virtual link may not be validated, or the virtual link may be invalidated if the virtual link is already validated.

The plurality of multihop access networks include the multihop access network 104 and the other multihop access network of the same kind as the multihop access network 104. The other multihop access network of the same kind can be a network using the same communication protocol (same MAC protocol) as the multihop access network 104 and to which a different ID is allocated. In such a manner, when the plurality of multihop access networks can be connected, since the multihop access networks partially overlap and are redundant, by not validating or invalidating the virtual link, loads of the interworking relay can be reduced. However, when the gateway node is not present in one of or both of the multihop access networks, the virtual link may not be invalidated in order to secure access to the core network.

Also, the virtual link management unit 201 may control the validation and invalidation of the virtual link by an instruction from the interworking gateway 102. In order to make the operation possible, the virtual link management unit may request registration of the interworking relay, which is the present node, to the interworking gateway 102. At the time, an MIH Registration function defined by IEEE 802.21 may be used.

The virtual link management unit 201 may acquire information related to communication quality of the multihop access network 104 through the multihop MAC/PHY unit 203 and may validate and invalidate the virtual link using the information. Also, using the information, a communication resource required for exchanging the MAC frame on the virtual link may be secured on the interworking network 106 (for instance, specification of priority of call control or the like). Also, by outputting a communication resource request to the multihop access network 104 through the multihop MAC/PHY unit 203, the virtual link management unit 201 may reserve a communication resource to the multihop access network 104 (for instance, specification of the priority of packet transfer or the like).

The virtual link transmission/reception unit 202 transmits the MAC frame inputted from the multihop MAC/PHY unit 203 when the virtual link is validated, to the interworking gateway using the virtual link. Also, the virtual link transmission/reception unit 202 outputs the MAC frame received from the interworking gateway 102 through the virtual link to the multihop MAC/PHY unit 203.

The multihop MAC/PHY unit 203 has a MAC function and a PHY function of the multihop access network 104. Specifically, the multihop MAC/PHY unit 203 transmits and receives MAC/PHY frames. There are a data frame and a control frame and the like, as the kinds of frames. Also, the multihop MAC/PHY unit acquires communication quality information of the multihop access network 104, secures the communication resource in the multihop access network 104, and establishes a logical link with an adjacent multihop MAC node or the like. The adjacent multihop MAC node includes not only a node of the multihop access network 104 but also the interworking gateway 102, and the virtual link is also included as the logical link.

The relay processing unit 204 executes the route control of the multihop access network 104 including the virtual link. The relay processing unit 204 determines a relay destination of a packet, on the basis of header information (destination address or the like) of the packet included in the MAC frame received in the virtual link transmission/reception unit 202 or the multihop MAC/PHY unit 203. When the destination of the packet is a present device (relay), the packet is processed in the relay processing unit 204 or in a high-order processing unit. When the destination is not the present device, a request is outputted to the multihop MAC/PHY unit 203 so as to transmit the MAC frame including the packet to the specified relay destination.

Also, an address used for determination of the relay destination is different depending on a route control protocol to be used. For instance, the route control is executed on the basis of an IP address when executing the route control by IP, the route control is executed by a MAC address when executing the route control by MAC, and when executing the route control by other protocols, an address defined by the protocol may be used. When executing the route control by the MAC address, in addition to normal source MAC address and destination MAC address, a header for the route control to be rewritten in respective relay nodes is added. The header for the route control has a hop-by-hop source MAC address and a hop-by-hop destination MAC address. It is conceivable that, when a certain node adds the header for the route control, the hop-by-hop source MAC address is the MAC address of the present node, and the hop-by-hop destination MAC address is the MAC address of the next hop node.

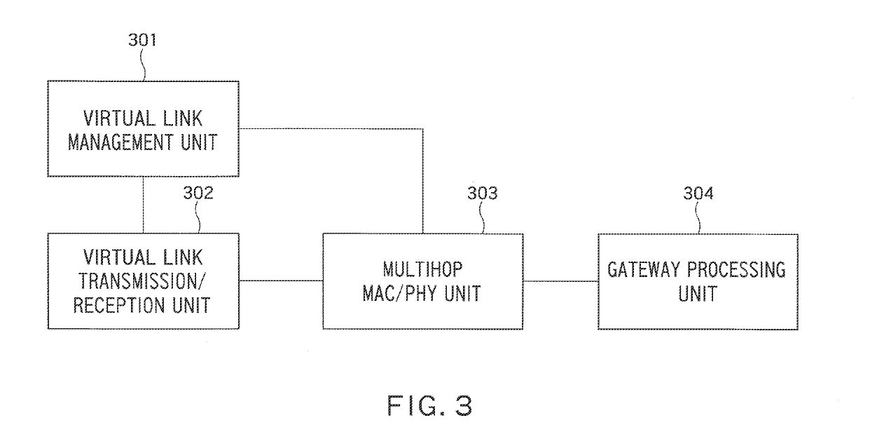

Next, one configuration of the interworking gateway related to the first embodiment is illustrated in FIG. 3. In FIG. 3, the interworking gateway includes a virtual link management unit 301, a virtual link transmission/reception unit 302, a multihop MAC/PHY unit 303, and a gateway processing unit 304. The virtual link management unit 301 validates and invalidates the virtual link. The virtual link management unit may have a function of instructing the validation and invalidation of the virtual link to the interworking relay 101. The virtual link management unit 301 may acquire information related to communication quality of the multihop access network (not shown in the figure) connected to the multihop MAC/PHY unit 303 and may validate and invalidate the virtual link using the information. Also, using the information, a communication resource required for exchanging the MAC frame on the virtual link may be secured on the interworking network.

The virtual link transmission/reception unit 302 transmits the MAC frame inputted from the multihop MAC/PHY unit 303 when the virtual link is validated, to the interworking relay 101 using the virtual link. Also, the virtual link transmission/reception unit 302 outputs the MAC frame received from the interworking relay 101 through the virtual link to the multihop MAC/PHY unit 303.

The multihop MAC/PHY unit 303 has a MAC function of the multihop access network. Specifically, the multihop MAC/PHY unit 303 has functions of transmitting and receiving the MAC frames (data frames and control frames), acquiring and providing communication quality information of the multihop access network, securing the communication resource in the multihop access network, and establishing a logical link with an adjacent multihop MAC node or the like. The adjacent multihop MAC node includes not only a node of the multihop access network but also the interworking relay, and the virtual link is also included as the logical link. The multihop MAC/PHY unit may remove a PHY function in the case of a form of not being directly connected to the multihop access network.

The gateway processing unit 304 executes the route control of the multihop access network 104 including the virtual link and an external network (core network or the like). The gateway processing unit 304 determines a relay destination of a packet of a frame received from the outside (the virtual link or somewhere other than the virtual link) from header information. When the destination of the packet is a present device (relay), the packet is processed in the gateway processing unit 304 or in a high-order processing unit. When the destination is not the present device, whether the MAC address of the specified relay destination is a multihop MAC is determined, and when it is not the multihop MAC, a frame including the packet is generated and outputted to the external network. When it is the multihop MAC, a request is outputted to the multihop MAC/PHY unit 303 so as to transmit the MAC frame including the packet.

In the multihop MAC/PHY unit 303, the MAC frame including the packet is generated, and when there is no virtual link with the relay destination, the MAC frame is transmitted to the multihop access network (not shown in the figure) connected to the multihop MAC/PHY unit 303. When the virtual link is set, the transmission of the MAC frame is requested to the virtual link transmission/reception unit 302. In the virtual link transmission/reception unit 302, the MAC frame is transmitted by the virtual link.

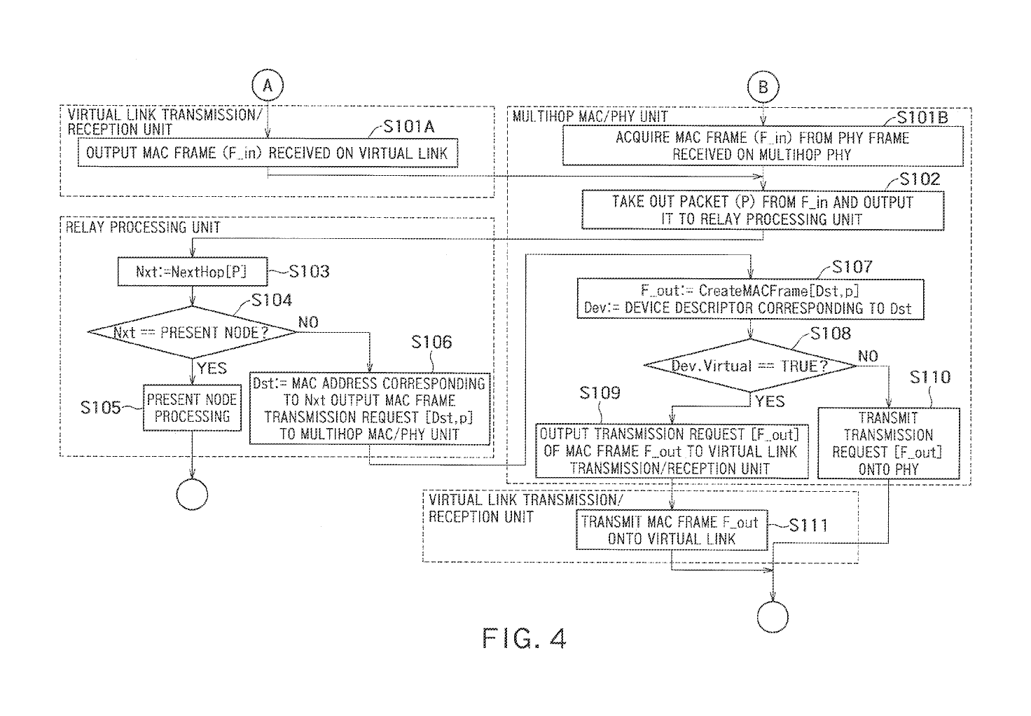

Next, an operation during MAC frame transmission and reception of the interworking relay according to the first embodiment will be described using FIG. 4.

A flowchart in FIG. 4 has two start points “A” and “B.” The start point “A” is the start point in the case of receiving the multihop MAC frame on the virtual link. The start point “B” is the start point in the case of receiving the multihop MAC frame on the multihop PHY.

In the case of receiving the multihop MAC frame on the virtual link, the virtual link transmission/reception unit 202 outputs a received MAC frame (F_in) to the multihop MAC/PHY unit 203 (S101A), and advances to step S102. On the other hand, in the case of receiving the multihop MAC frame on the multihop PHY, the multihop MAC/PHY unit 203 acquires a MAC frame (F_in) from a received PHY frame (S101B) and advances to step S102.

In step S102, the multihop MAC/PHY unit 203 takes out a packet (P) from the MAC frame F_in, and outputs it to the relay processing unit 204.

Then, in the relay processing unit 204, the next hop node of the packet P is retrieved (NextHop [P]), and the retrieved next hop node is defined as “Nxt” (S103). The next hop node is determined according to a route control table prepared by a route control protocol (RPL, for instance). As described above, the route control can be executed by IP, MAC or other protocols.

If the next hop node is the present node (S104: Y), the relay processing unit 204 delivers the packet to a pertinent application, processes the packet P in the present node (S105), and ends the processing.

If the next hop node is not the present node (S104: N), the MAC address corresponding to the next hop node is acquired, and with it determined as “Dst,” a MAC frame transmission request [Dst,P] is outputted to the multihop MAC/PHY unit 203 (S106).

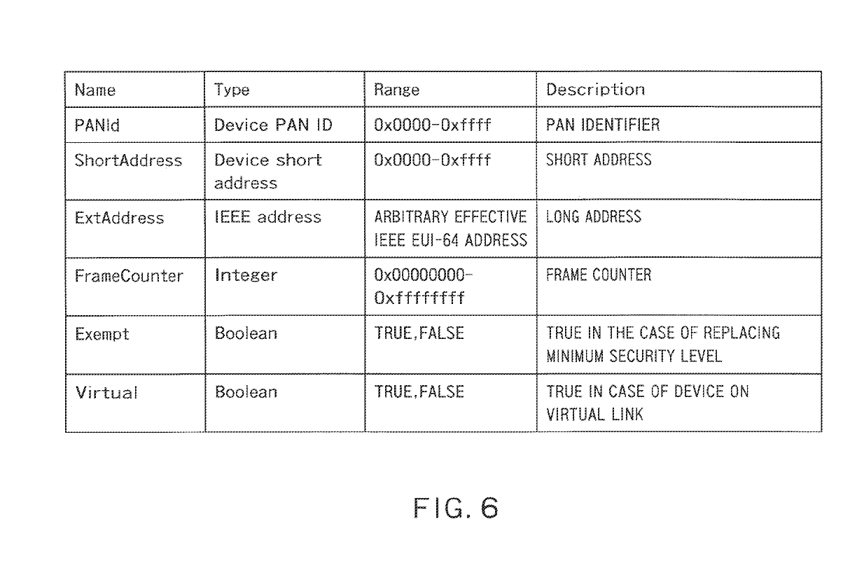

The multihop MAC/PHY unit 203 creates a MAC frame for transmission from “Dst” and “P” (CreateMACFrame[Dst,P]), sets the created MAC frame to “F_out,” and sets a device descriptor (DeviceDescriptor) corresponding to “Dst” (see FIG. 6 described later) to “Dev” (S107). As described later, the device descriptor is created for each adjacent MAC node.

A virtual flag of the device descriptor “Dev” is checked (S108), and when the virtual flag is true (S108: Y), a transmission request [F_out] of the MAC frame (F_out) is outputted to the virtual link transmission/reception unit 202. The virtual link transmission/reception unit 202 transmits the MAC frame (F_out) by the virtual link (S111), and ends the processing. That is, the frame of the MAC of the interworking network including the MAC frame (F_out) is generated and the generated frame is transmitted to the interworking network.

On the other hand, when the virtual flag is false (S108: N), the MAC function of the multihop MAC/PHY unit 203 sends the transmission request [F_out] of the MAC frame (F_out) to the multihop PHY of the multihop MAC/PHY unit 203 (S110). The multihop PHY of the multihop MAC/PHY unit 203 transmits the MAC frame “F_out” to the multihop access network 104, and ends the processing.

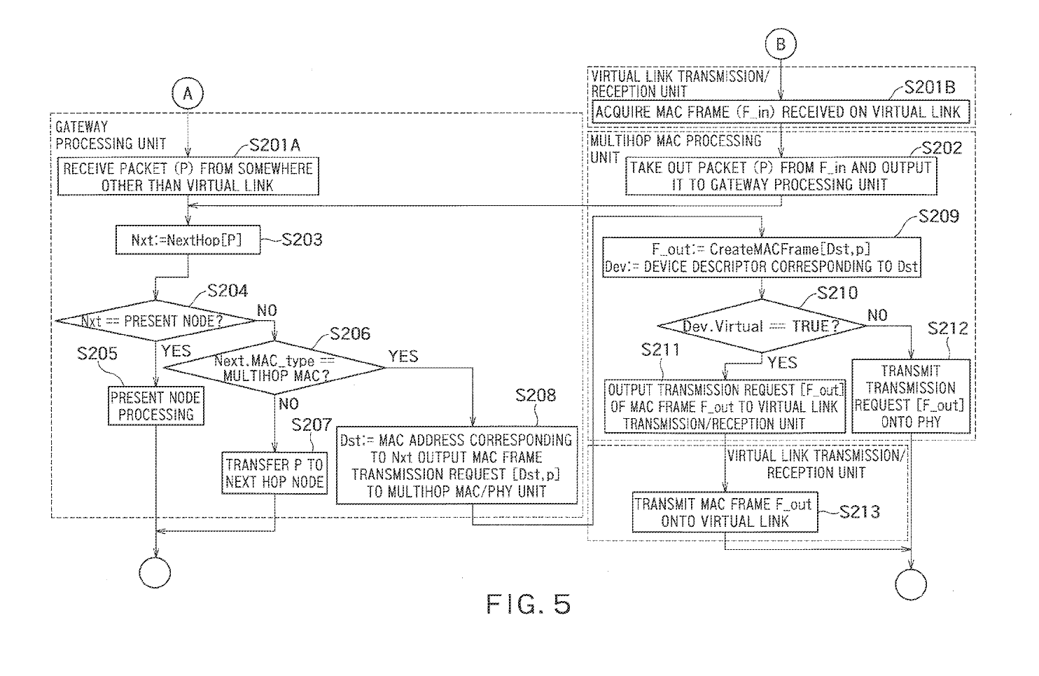

Next, an operation during MAC frame transmission and reception of the interworking gateway according to the first embodiment will be described using FIG. 5.

A flowchart in FIG. 5 has two start points “A” and “B.” The start point “A” is the start point in the case of receiving a packet “P” from somewhere other than the virtual link. The start point “B” is the start point in the case of receiving the multihop MAC frame on the virtual link. Receiving the multihop MAC frame on the virtual link means receiving a frame of the interworking MAC including the multihop MAC frame from the interworking network.

As the case of receiving the packet P from somewhere other than the virtual link at the start point “A,” there is the case that the gateway processing unit 304 receives the packet of the frame received from the core network. Also, when the multihop MAC/PHY unit 303 is connected to the multihop access network, there is the case of receiving the packet of the frame received from the multihop access network.

In the case of receiving the packet P from somewhere other than the virtual link (S201A), and the processing advances to step S203.

On the other hand, in the case of receiving the multihop MAC frame on the virtual link, the virtual link transmission/reception unit 302 outputs the received multihop MAC frame (F_in) to the multihop MAC/PHY unit 303 (S201B). The multihop MAC/PHY unit 303 takes out the packet “P” from the MAC frame “F_in,” delivers it to the gateway processing unit 304 (S202), and the process advances to step S203.

The gateway processing unit 304 retrieves the next hop node of the packet “P” (NextHop [P]), and defines the retrieved next hop node as “Nxt” (S203). If the next hop node is the present node (S204: Y), the packet is delivered to a pertinent application, the packet “P” is processed in the present node (S205), and the processing is ended.

If the next hop node is not the present node (S204: N), whether the MAC type (Next.MAC_type) of the next hop node “Nxt” is the multihop MAC is checked (S206). The MAC address of the next hop node “Nxt” is specified and whether the MAC address is the multihop MAC may be checked.

When the MAC type of the next hop node “Nxt” is not the multihop MAC (S206: N), the gateway processing unit 304 transmits the packet “P” to the next hop node (a node inside the core network, for instance) (S207), and ends the processing.

When the MAC type of the next hop node “Nxt” is the multihop MAC (S206: Y), the MAC address of the next hop node is defined as “Dst,” and a transmission request [Dst,P] of the MAC frame is outputted to the multihop MAC/PHY unit 303 (S208).

The multihop MAC/PHY unit 303 creates a transmission MAC frame from “Dst” and “P” (CreateMACFrame[Dst,P]), sets it to “F_out,” and sets a device descriptor corresponding to “Dst” to “Dev” (S209).

A virtual flag of the device descriptor “Dev” is checked (S210), and when the virtual flag is true (S210: Y), a transmission request [F_out] of the MAC frame “F_out” is outputted to the virtual link transmission/reception unit 302. The virtual link transmission/reception unit 302 transmits the MAC frame “F_out” through the virtual link (S213), and ends the processing.

On the other hand, when the virtual flag is false (S210: N), the MAC function of the multihop MAC/PHY unit 303 sends the transmission request [F_out] of the MAC frame “F_out” to the multihop PHY of the multihop MAC/PHY unit 303 (S212). This processing can occur when the multihop MAC/PHY unit 303 is connected to the multihop access network. The multihop PHY of the multihop MAC/PHY unit 303 transmits the MAC frame F_out, and ends the processing.

In FIG. 6, examples of the device descriptor (DeviceDescriptor) of the multihop MAC/PHY units 203 or 303 are illustrated. For the device descriptor, an entry is created for each adjacent MAC node, and the device descriptor for one MAC node are illustrated in FIG. 6. Data of the device descriptor is stored inside the multihop MAC/PHY unit, or in a storage that can be accessed from the multihop MAC/PHY unit.

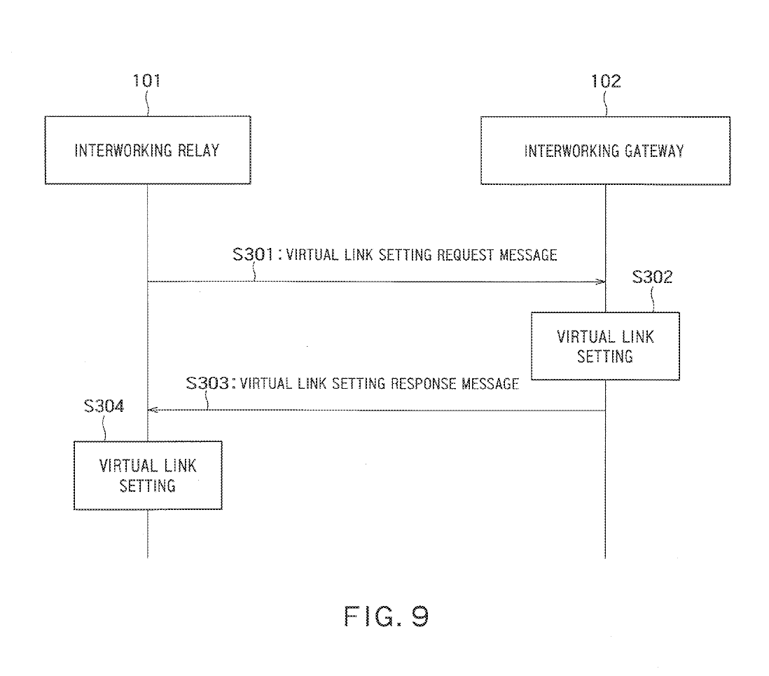

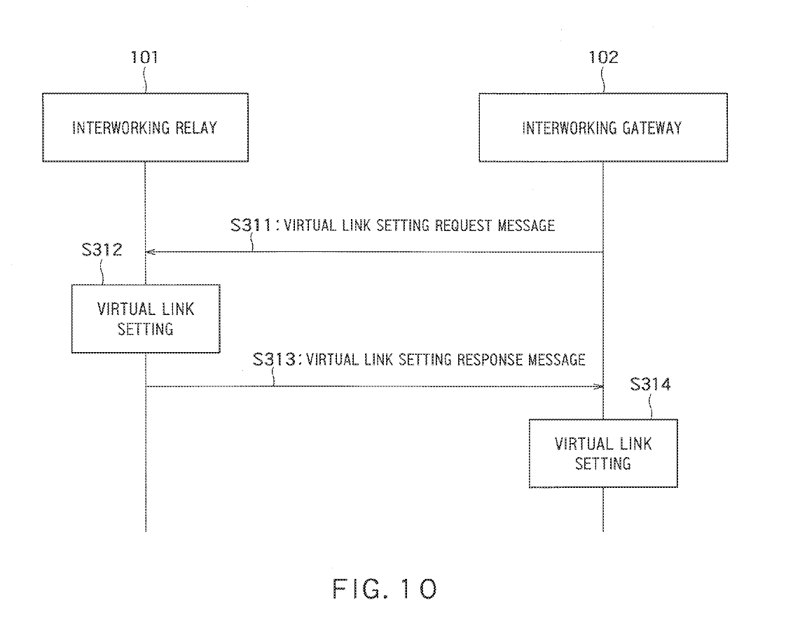

In FIG. 6, definitions and usages of attributes other than “Virtual” are described in IEEE 802.15.4-2011. For the MAC address described so far, either one of the “short address” and the “long address” that is determined beforehand can be used. “Virtual” is set to “TRUE” when a connection with the adjacent MAC node is performed through the virtual link, and is set to “FALSE” otherwise when the connection is performed through a physical link capable of direct communication using the multihop PHY. The virtual link management units 201 and 301 set the value of “Virtual” in a setting sequence of the virtual link described later (see FIG. 9 and FIG. 10).

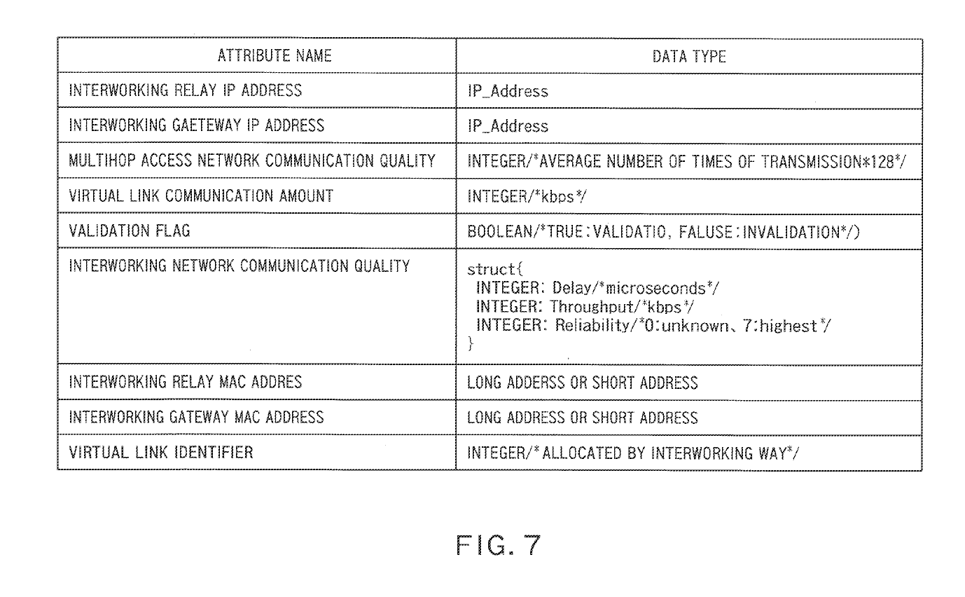

In FIG. 7, examples of virtual link management information in the virtual link management units 203 and 303 are illustrated. The virtual link management information is prepared for each set of the interworking relay and the interworking gateway to which the virtual link is set. The virtual link management information is stored inside the virtual link management unit, or inside a storage that can be accessed from the virtual link management unit. The virtual link management unit updates and manages the virtual link management information.

In the examples in FIG. 7, the virtual link management information includes an interworking relay IP address, an interworking gateway IP address, a multihop access network communication quality (the average number of times of retransmission*128), a virtual link communication amount (kilobits/second), a validation flag (“TRUE” when the virtual link is validated and “FALSE” when it is invalidated), interworking network communication quality, an interworking relay MAC address, an interworking gateway MAC address, and a virtual link identifier. The interworking relay MAC address, the interworking gateway MAC address and the virtual link identifier may be set when the validation flag becomes “TRUE.” The multihop access network communication quality and the interworking network communication quality may be periodically measured and updated regardless of validity/invalidity of the virtual link.

The interworking network communication quality has delay (microseconds), throughput (kbps), and reliability (an integer value of 0 to 7, 0 is “reliability unknown,” and 7 is “reliability maximum.”) as elements. The validation flag may be set using an interworking protocol described later. The virtual link identifier is allocated by the virtual link management unit of the interworking gateway, but a configuration of being allocated by the virtual link management unit of the interworking relay is also possible.

Also, the virtual link management unit 201 may estimate a route control metric related to the virtual link on the basis of the communication quality of the interworking network and may advertise it to the multihop access network. For instance, when using RPL described in RFC6550 for the route control protocol, values of the delay, throughput and reliability of the communication quality of the interworking network are used respectively as metric values of latency, throughput and link reliability of an RPL route control metric defined in RFC6550. Information of the advertised route control metric can be utilized in generation of route information in the multihop access network including the virtual link, for instance. In this case, when the values of the delay, throughput and reliability do not satisfy respective prescribed references, the route information of not transferring a frame to a relay can be generated. While the virtual link management unit 201 is described here, the virtual link management unit 301 is the same.

Also, the virtual link management unit 201 may make the multihop MAC/PHY unit execute channel scan of the multihop access network. At the time, if detecting the same multihop network ID as a multihop network ID (“PANId” in FIG. 6 or the like) used by the multihop access network on a channel (defined as a channel “B,” for instance) different from a channel (defined as a channel “A,” for instance) used by the multihop access network to which the interworking relay is currently connected, the virtual link may not be validated, or the virtual link may be invalidated if the virtual link is already validated. Thus, when the multihop access network is redundant, load increase of the interworking gateway can be suppressed. It is just as described briefly above.

The virtual link management unit 201 may control the validation and invalidation of the virtual link corresponding to the communication quality of the multihop access network. For instance, in the case of using the average number of times of MAC frame transmission (ETX) as the communication quality of the multihop access network, the virtual link may be invalidated when an ETX value falls below a certain threshold. In this case, the virtual link management unit 201 requests releasing of the virtual link to the virtual link management unit 301, and sets the validation flag in the respective virtual link management information to “FALSE.” Also, as described later, a configuration of requesting the releasing of the virtual link from an interworking gateway side is also possible. By invalidating the virtual link, the interworking gateway is logically cut off from the multihop access network 104, and it is considered that the possibility that a route to the interworking gateway is eliminated from the route control information of the multihop access network becomes high.

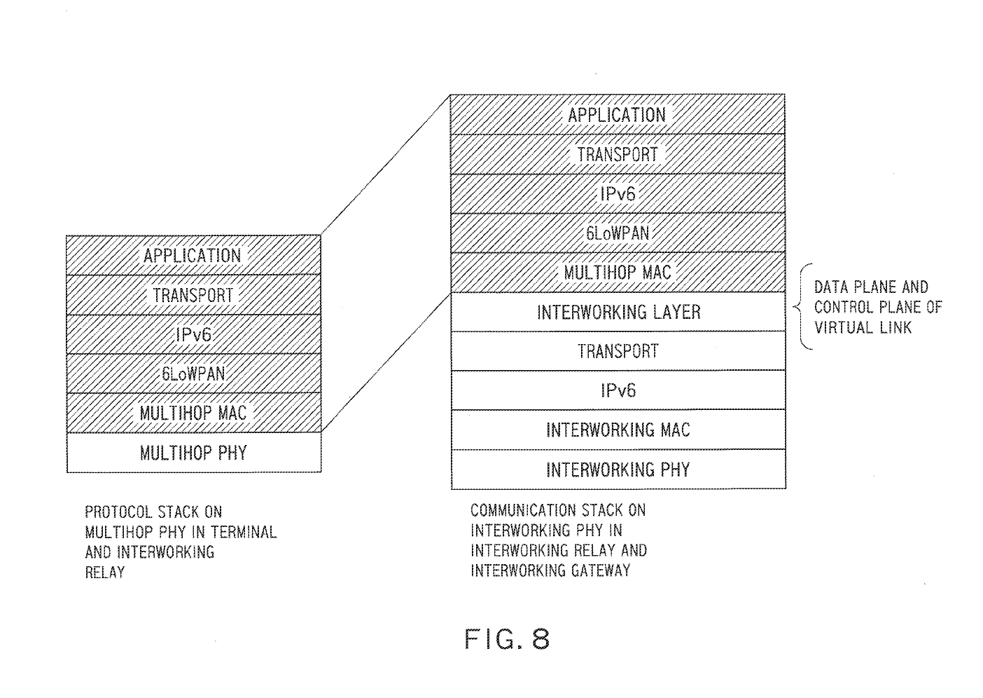

In FIG. 8, a protocol stack related to this embodiment is illustrated.

The left side of FIG. 8 illustrates the protocol stack on the multihop PHY, and the right side of FIG. 8 illustrates the protocol stack on interworking network PHY.

The protocol stack on the multihop PHY has layers of the multihop PHY, the multihop MAC, 6LoWPAN, IPv6 and a transport application, from a low order layer.

The protocol stack on the interworking network PHY has layers of interworking PHY, interworking MAC, IPv6, transport, and interworking (the data plane and control plane of the virtual link), and the higher order of the interworking layer has the same stack structure as the multihop MAC layer and higher of the protocol stack on the multihop PHY.

Hereinafter, a sequence of setting and releasing of the virtual link using the interworking protocol will be described. A configuration of requesting setting and releasing of the virtual link from the interworking relay and a configuration of requesting setting and releasing of the virtual link from the interworking gateway are possible.

In FIG. 9, a virtual link setting sequence initiated by the interworking relay is illustrated.

The virtual link management unit 201 of the interworking relay 101 transmits a virtual link setting request message to the interworking gateway 102 through the virtual link transmission/reception unit 202 (S301). The virtual link transmission/reception unit 202 transmits the virtual link setting request message not by the virtual link but by a normal physical link in the interworking network 106. The virtual link setting request message may be transmitted periodically like every 10 minutes.

The virtual link management unit 301 of the interworking gateway 102 sets the virtual link on the basis of the virtual link setting request (S302). At the time, the virtual flag of the device descriptor is set to “TRUE,” the validation flag of the virtual link management information is set to “TRUE,” and further, the interworking relay MAC address, the interworking gateway MAC address, and the virtual link identifier are set.

When the virtual link is set, the virtual link management unit 301 of the interworking gateway 102 transmits a virtual link setting response message to the interworking relay 101 through the virtual link transmission/reception unit 302 (S303). The virtual link transmission/reception unit 302 transmits the virtual link setting response message not by the virtual link but by the normal physical link in the interworking network 106. In the virtual link setting response message, the virtual link identifier may be included.

The interworking relay 101 sets the virtual link on the basis of a virtual link setting response (S304). At the time, the virtual flag of the device descriptor is set to “TRUE,” the validation flag of the virtual link management information is set to “TRUE,” and further, the interworking relay MAC address, the interworking gateway MAC address, and the virtual link identifier notified from the interworking gateway 102 may be set.

In FIG. 10, a virtual link setting sequence initiated by the interworking gateway is illustrated. Descriptions that overlap with FIG. 9 are omitted.

The virtual link management unit 301 of the interworking gateway 102 transmits a virtual link setting request message to the interworking relay 101 through the virtual link transmission/reception unit 302 (S311). At the time, the virtual link identifier may be generated and the virtual link identifier may be included in the virtual link setting request message.

The virtual link management unit 201 of the interworking relay 101 sets the virtual link on the basis of the virtual link setting request (S312).

When the virtual link is set, the virtual link management unit 201 of the interworking relay 101 transmits a virtual link setting response message to the interworking gateway 102 through the virtual link transmission/reception unit 202 (S313).

The interworking gateway 102 sets the virtual link on the basis of a virtual link setting response (S314). The virtual link identifier may be notified to the interworking relay 101 not when transmitting the virtual link setting request message but after receiving the virtual link setting response message from the interworking relay 101.

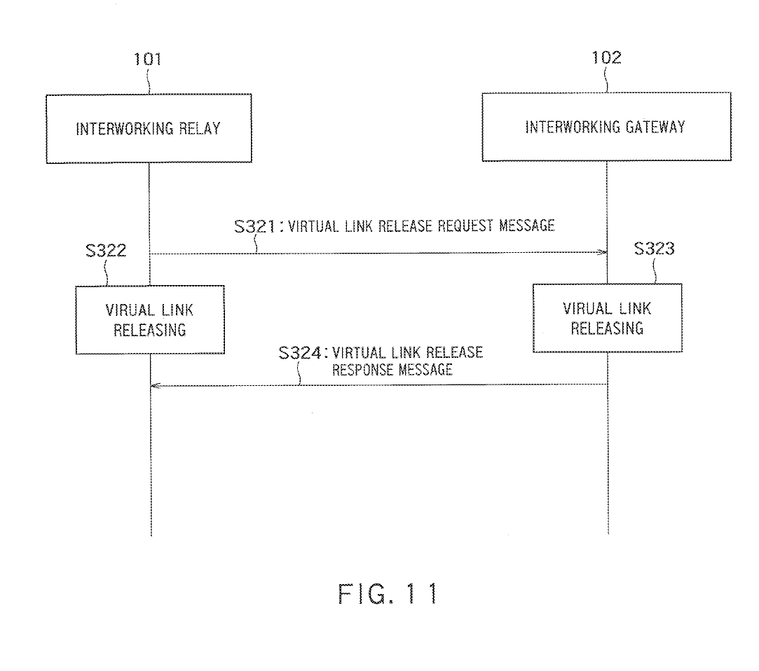

In FIG. 11, a virtual link release sequence initiated by the interworking relay is illustrated.

The virtual link management unit 201 of the interworking relay 101 transmits a virtual link release request message to the interworking gateway 102 through the virtual link transmission/reception unit 202 (S321). In the virtual link release request message, the virtual link identifier of the virtual link to be a releasing target may be included. Also, the virtual link transmission/reception unit 202 transmits the virtual link release request message not through the virtual link but through the normal physical link in the interworking network 106.

When the virtual link release request message is transmitted, the virtual link management unit 201 releases the virtual link (S322). At the time, the virtual flag of the device descriptor is set to “FALSE,” and the validation flag of the virtual link management information is set to “FALSE.” Furthermore, the interworking relay MAC address, the interworking gateway MAC address and the virtual link identifier in the virtual link management information may be reset according to the configuration.

The virtual link management unit 301 of the interworking gateway 102 releases the virtual link on the basis of the virtual link release request (S323). Specifically, the virtual link of the virtual link identifier included in the virtual link release request is released. The virtual link management unit 301 sets the virtual flag of the device descriptor to “FALSE,” and sets the validation flag of the virtual link management information including the virtual link identifier to “FALSE.” Furthermore, the interworking relay MAC address, the interworking gateway MAC address and the virtual link identifier may be reset according to the configuration.

When the virtual link is released, the virtual link management unit 301 of the interworking gateway 102 transmits a virtual link release response message to the interworking relay 101 through the virtual link transmission/reception unit 302 (S324). Also, the virtual link transmission/reception unit 302 transmits the virtual link release response message not through the virtual link but through the normal physical link in the interworking network 106. In the virtual link setting response message, the virtual link identifier may be included.

While the interworking relay 101 releases the virtual link immediately after transmitting the virtual link release request message in the sequence in FIG. 11, the virtual link may be released after receiving the virtual link release response message from the interworking gateway.

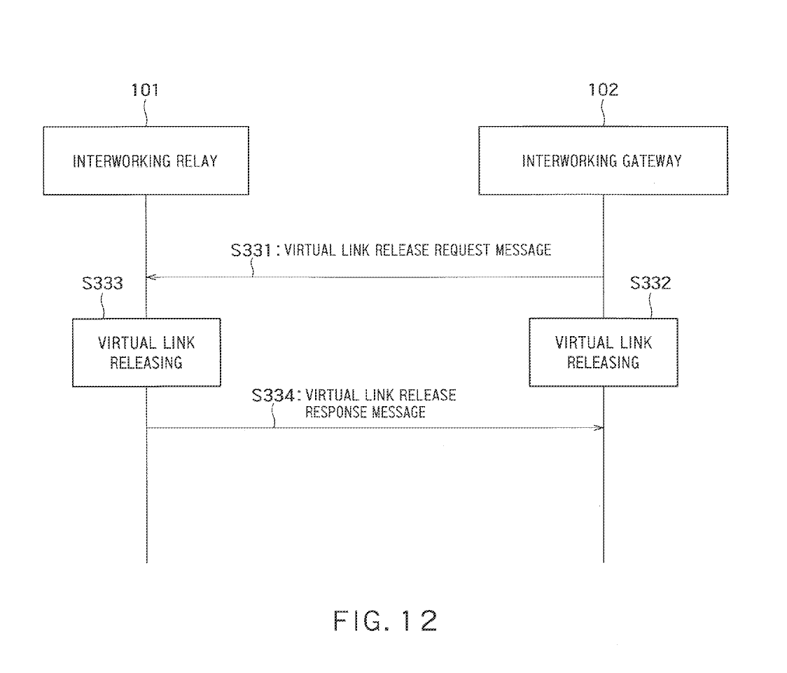

In FIG. 12, a virtual link release sequence initiated by the interworking gateway is illustrated. Descriptions that overlap with FIG. 11 are omitted.

The virtual link management unit 301 of the interworking gateway 102 transmits a virtual link release request message to the interworking relay 101 through the virtual link transmission/reception unit 302 (S331). In the virtual link release request message, the virtual link identifier of the virtual link to be a releasing target may be included.

When the virtual link release request message is transmitted, the virtual link management unit 301 releases the virtual link (S332).

The virtual link management unit 201 of the interworking relay 101 releases the virtual link on the basis of the virtual link release request (S333). Specifically, the virtual link of the virtual link identifier included in the virtual link release request is released.

When the virtual link is released, the virtual link management unit 201 of the interworking relay 101 transmits a virtual link release response message to the interworking gateway 102 through the virtual link transmission/reception unit 202 (S334). Also, in the virtual link release response message, the virtual link identifier may be included.

While the interworking gateway 102 releases the virtual link immediately after transmitting the virtual link release request message in the sequence in FIG. 12, the virtual link may be released after receiving the virtual link release response message from the interworking relay.

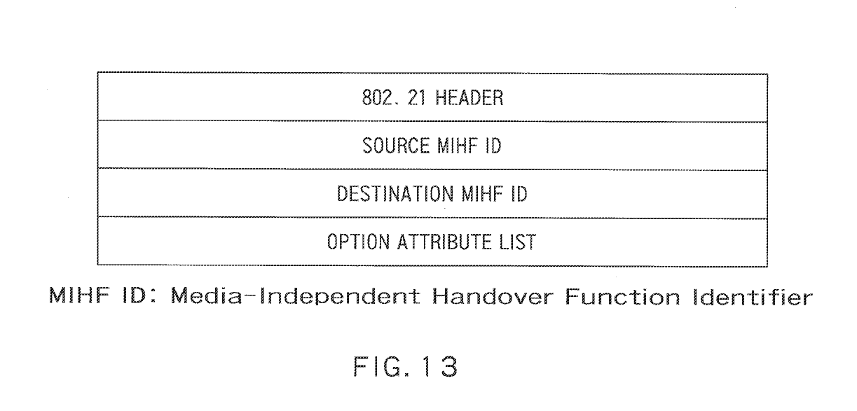

In FIG. 13, one example of an interworking protocol message format is illustrated. In FIG. 13, an example using IEEE 802.21 as the interworking protocol is illustrated.

An interworking protocol message includes a 802.21 header, a source MIHF (Media-Independent Handover Function ID), a destination MIHF ID, and a list of option attributes. A message type of the interworking protocol is identified by the MIH Message ID of a message inside the 802.21 header.

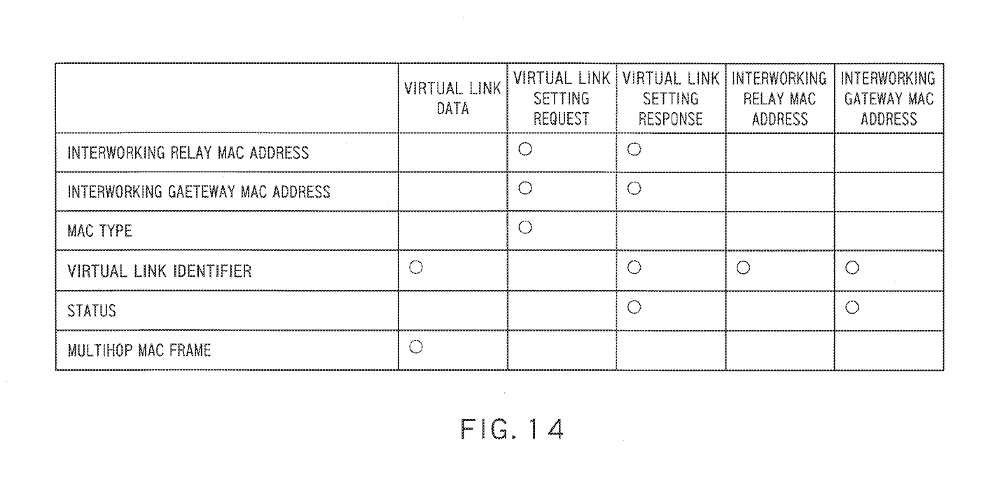

In FIG. 14, a correspondence table of the option attributes of the interworking protocol message is illustrated.

Item names “virtual link data,” “virtual link setting request,” “virtual link setting response,” “virtual link release request” and “virtual link release response” In a vertical column correspond to the message types, respectively.

The item names “interworking relay MAC address,” “interworking gateway MAC address,” “MAC type,” “virtual link identifier,” “status,” and “multihop MAC frame” of a horizontal column respectively correspond to the option attributes.

The “MAC type” indicates the type of the MAC of the multihop access network. The “virtual link identifier” is identification information of the virtual link allocated by the multihop gateway. The “status” indicates the state of success and failure of virtual link setting processing or virtual link releasing processing. The “multihop MAC frame” is the MAC frame exchanged on the virtual link.

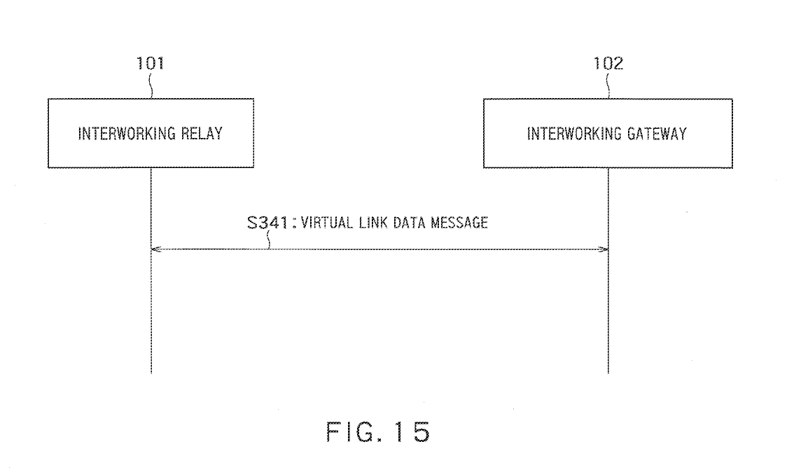

In the column of the respective message types, the option attribute included in a message whose message type is specified is circled. For instance, when the message type is the “virtual link data,” as the option attributes, the virtual link identifier and the data of the multihop MAC frame are included. In FIG. 15, a multihop MAC frame transfer sequence on the virtual link using the interworking protocol is illustrated.

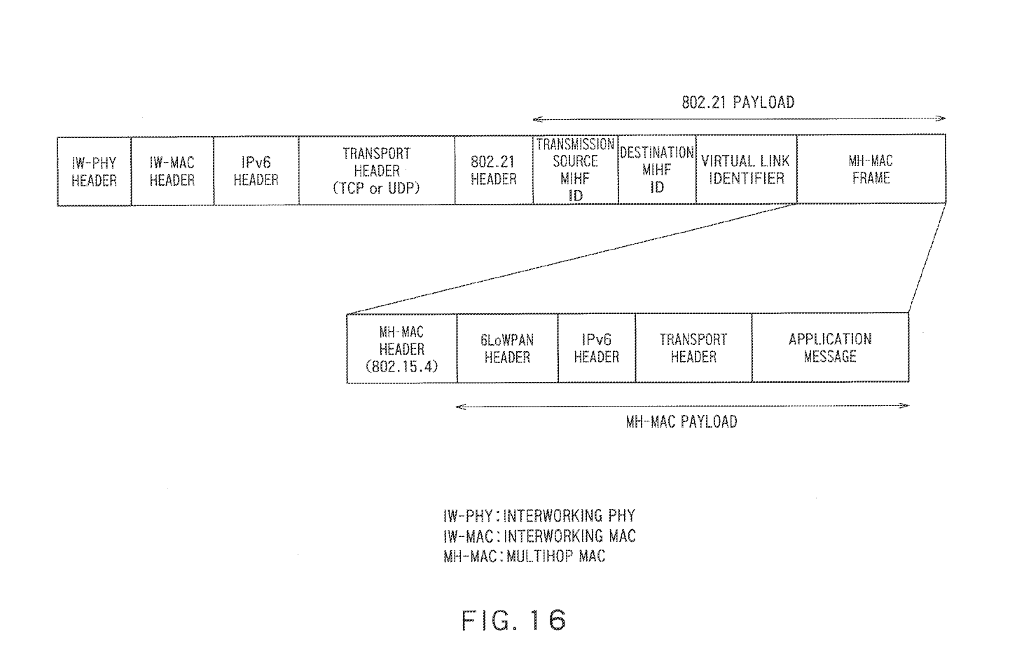

The interworking relay 101 transmits the MAC frame determined to be transmitted by the virtual link in the flow illustrated in FIG. 4, using the virtual link (S341). The interworking gateway 102 also transmits the MAC frame determined to be transmitted by the virtual link in the flow illustrated in FIG. 5, using the virtual link. In transmission using the virtual link, as illustrated in FIG. 14, the option attribute is “virtual link data,” and the virtual link identifier and the MAC frame are sent as the option attributes of the interworking protocol message. In FIG. 16, an example of a packet format at the time is illustrated. To a 802.21 payload, as the option attributes, the virtual link identifier and data of the MAC frame (multihop MAC frame) are added.

In this embodiment, an example of setting and releasing the virtual link on the basis of the communication quality of the multihop access network and the interworking network is described, but a configuration of attaining the state of setting the virtual link at all times regardless of the communication quality of the multihop access network and the interworking network is also possible. In this case, by not selecting a route to the interworking gateway by the operation of the route control protocol when the communication quality of the interworking network is low, for instance, an effect similar to that of not setting the virtual link is practically obtained.

As described above, by the node device according to the first embodiment, by using the interworking relay connectable to both of the multihop access network and the interworking network, the connectivity of the multihop access network and the core network is maintained even if a gateway node of the multihop access network fails, by securing connectivity with the interworking gateway outside the multihop access network through the interworking relay and thus, the availability of a system can be improved. Furthermore, when the plurality of interworking relays are connected to one multihop access network, the availability of the system is further improved.

### Second Embodiment

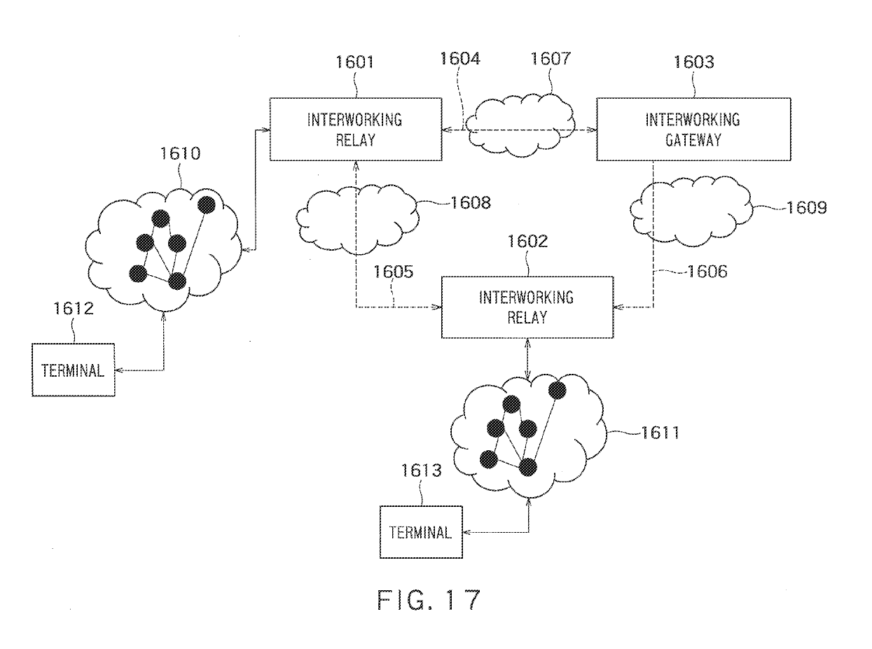

FIG. 17 illustrates a communication system according to the second embodiment.

The communication system according to the second embodiment includes interworking relays 1601 and 1602, an interworking gateway 1603, multihop access networks 1610 and 1611, terminals 1612 and 1613, and interworking networks 1607, 1608 and 1609.

The interworking relay 1601 is connected to the multihop access network 1610, the interworking network 1607, and the interworking network 1608 (third network). The interworking relay 1602 is connected to the multihop access network 1611 (fourth network) and the interworking networks 1608 and 1609. The interworking networks 1607, 1608 and 1609 are IP networks of arbitrary types.

The interworking gateway 1603 is connected to the interworking networks 1607 and 1609. In a typical configuration, the interworking gateway 1603 is also connected to a core network not shown in the figure. Also, the interworking gateway 1603 may be connected to a multihop access network different from the multihop access networks and 1611.

The interworking relay 1601 and the interworking gateway 1603 are capable of validating and invalidating the virtual link 1604, the interworking relay 1601 and the interworking relay 1602 are capable of validating and invalidating the virtual link 1605, and the interworking relay and the interworking gateway 1603 are capable of validating and invalidating the virtual link 1606. Differently from the first embodiment, in this embodiment, the MAC frame (which may be the multihop MAC frame) can be transferred by the virtual link even between the interworking relays with each other in this embodiment.

The terminal 1612 is connected to the multihop access network 1610. The terminal 1613 is connected to the multihop access network 1611.

To the multihop access networks 1610 and 1611, a gateway node, not shown in the figure, may be connected. As the MAC protocol of the multihop access networks 1610 and 1611, the IEEE 802.15.4 may be used. The route control inside the multihop access networks 1610 and 1611 may be executed in an IP layer, or may be executed in a layer of a lower order than the IP layer. When executing the route control in the IP layer, as the route control protocol of the IP layer, RPL defined in RFC 6550 may be used.

The configuration of the interworking relays 1601 and and the interworking gateway 1603 related to the second embodiment is basically the same as the first embodiment. As a point different from the first embodiment, in this embodiment, the virtual link is set between the interworking relays. Therefore, while the interworking gateway has a function of setting a virtual link identifier mainly in the first embodiment, the interworking relay also has the function in this embodiment.

In such a manner, according to the second embodiment, in addition to the advantages of the first embodiment, even when one of the interworking networks 1607, 1608 and 1609 becomes unavailable, bypassing to another interworking network is possible, and therefore the availability of the system can further be improved.

The interworking relay and the interworking gateway as described above may also be realized using a general-purpose computer device as basic hardware. That is, processing of each block in the interworking relay and the interworking gateway can be realized by causing a processor mounted in the above general-purpose computer device to execute a program. In this case, the interworking relay and the interworking gateway may be realized by installing the above described program in the computer device beforehand or may be realized by storing the program in a storage medium such as a CD-ROM or distributing the above described program over a network and installing this program in the computer device as appropriate. Furthermore, the storage in the interworking relay and the interworking gateway may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A relay device comprising:
a first connection unit to connect to a first network;
a second connection unit to connect to a second network;
a virtual link management unit to control setting and releasing of a virtual link to logically connect a gateway existing in the second network to the first network, according to a predetermined condition;
a relay processing unit to determine a relay destination of a packet received from the first network; and
a virtual link transmission/reception unit to transmit the packet to the gateway in association with the virtual link, when the relay destination of the packet is determined to be the gateway and the virtual link is set to the gateway.

2. The relay device according to claim 1,
wherein the virtual link management unit acquires communication quality information of the first network through the first connection unit, and controls setting and releasing of the virtual link on the basis of the communication quality information of the first network.

3. The relay device according to claim 1,
wherein the virtual link management unit acquires communication quality information of the second network through the second connection unit, and controls setting and releasing of the virtual link on the basis of the communication quality information of the second network.

4. The relay device according to claim 1,
wherein the virtual link management unit acquires communication quality information of the second network through the second connection unit, estimates a route control metric related to the virtual link in the second network on the basis of the communication quality information, and advertises information of the route control metric to the first network.

5. The relay device according to claim 1,
wherein the virtual link management unit acquires communication quality information of the second network through the second connection unit, and secures a communication resource in the second network on the basis of the communication quality information.

6. The relay device according to claim 1,
wherein the virtual link management unit measures a communication amount related to the virtual link in the second network, and secures a communication resource in the second network on the basis of the communication amount measured.

7. The relay device according to claim 1,
wherein the virtual link management unit does not set the virtual link or releases an already-set virtual link when the first connection unit is further connected to a different network using same communication protocol as the first network.

8. The relay device according to claim 1,
wherein the virtual link management unit controls setting and releasing of the virtual link according to a request from the gateway.

9. The relay device according to claim 1,
wherein
the virtual link transmission/reception unit receives a packet associated with the virtual link from the gateway, and
the first connection unit transmits the packet to the first network when it is determined by the relay processing unit that a relay destination of the packet is a node on the first network.

10. The relay device according to claim 1,
wherein the first network is a multihop wireless network in which a plurality of nodes relay and deliver a packet.

11. The relay device according to claim 1,
wherein the relay processing unit determines a relay destination of a packet received from the first network on the basis of header information of the packet.

12. The relay device according to claim 1,
wherein
the second connection unit further connects to a third network to which a first relay device is connected,
the virtual link management unit controls setting and releasing of a first virtual link to logically connect the virtual link transmission/reception unit to a fourth network to which the first relay device is further connected, through communication with the first relay device, and
the virtual link transmission/reception unit receives a packet associated with the first virtual link in the third network from the first relay device, and transmits the packet to the gateway in association with the virtual link, when the relay destination of the packet is determined as the gateway by the relay processing unit and the virtual link is set to the gateway.

13. The relay device according to claim 1,
wherein
the virtual link management unit keeps such a state that the virtual link is fixedly set to the gateway, and
the relay processing unit determines a relay destination of the packet according to route control information generated according to a route control protocol on the basis of communication quality of the first and second networks.

14. A communication system comprising a relay device and a gateway, the relay device being connected to a first network and a second network and the gateway being connected to the second network, wherein,
the relay device comprises:
a first virtual link management unit to control setting and releasing of a virtual link to logically connect the gateway to the first network, according to a predetermined condition;
a relay processing unit to determine a relay destination of a packet received from the first network; and
a first virtual link transmission/reception unit to transmit the packet to the gateway in association with the virtual link, when the relay destination of the packet is determined to be the gateway and the virtual link is set to the gateway, and
the gateway comprises:
a second virtual link management unit to control setting and releasing of the virtual link, through communication with the relay device;
a second virtual link transmission/reception unit to receive the packet in association with the virtual link from the second network.

15. A communication method comprising:
connecting to a first network;
connecting to a second network;
controlling setting and releasing of a virtual link to logically connect a gateway existing in the second network to the first network, according to a predetermined condition;
determining a relay destination of a packet received from the first network; and
transmitting the packet to the gateway in association with the virtual link, when the relay destination of the packet is determined to be the gateway and the virtual link is set to the gateway.

16. A non-transitory computer readable medium having instructions stored therein which causes when executed by a processor, to perform the processor processing of steps comprising:
connecting to a first network;
connecting to a second network;
controlling setting and releasing of a virtual link to logically connect a gateway existing in the second network to the first network, according to a predetermined condition;
determining a relay destination of a packet received from the first network; and
transmitting the packet to the gateway in association with the virtual link, when the relay destination of the packet is determined to be the gateway and the virtual link is set to the gateway.
